(19) United States
(12) Patent Application Publication
(10) Pub. No.: US 2026/0347595 A1
(43) Pub. Date: Nov. 5, 2026

(54) (METH)ACRYLIC COMPOSITION, FOAM MATERIAL OBTAINED FROM SUCH A COMPOSITION, METHOD FOR PRODUCING SAID COMPOSITION AND FOAM, AND USES THEREOF

(71) Applicant: Arkema France, Puteaux (FR)

(72) Inventors: Pierre GERARD, LACQ (FR); Nicolas VALLOIR, KING OF PRUSSIA, PA (US); Jérôme LE CORVEC, COLOMBES CEDEX (FR); Christophe RENAUD, MIRABEL, QUEBEC (CA); Daniel POIRIER, MIRABEL, QUEBEC (CA); Yves MATHIEU, WATERLOO, QUEBEC (CA)

(73) Assignee: Arkema France, Puteaux (FR)

(21) Appl. No.: 19/124,463

(22) PCT Filed: Oct. 24, 2023
(86) PCT No.: PCT/EP2023/079625

§ 371 Date: Apr. 25, 2025

(30) Foreign Application Priority Data
Oct. 25, 2022 (FR) FR2211086

(51) Int. Cl. C08L 33/12; C08J 9/00; C08J 9/06; C08J 9/12; C08J 9/224; C08J 9/232; C08J 9/236

(52) U.S. Cl. CPC C08L 33/12; C08J 9/0061; C08J 9/06; C08J 9/12; C08J 9/224; C08J 9/232; C08J 9/236; C08J 2203/22; C08J 2333/12; C08J 2433/12; C08L 2203/14; C08L 2203/18; C08L 2205/025; C08L 2205/03

(57) ABSTRACT

Embodiments relate to a (meth)acrylic composition suitable for preparing a (meth)acrylic foam, a process for preparing the (meth)acrylic composition and the (meth)acrylic foam and to a foam material obtained by polymerization of such a (meth)acrylic composition.

In particular embodiments relate to a (meth)acrylic composition suitable for preparing a (meth)acrylic foam, said meth)acrylic composition is comprising a liquid polymerizable (meth)acrylic syrup, a blowing agent and an initiating system for starting polymerization of said composition, a process for preparing the (meth)acrylic composition and the (meth)acrylic foam and also to a foam material obtained by polymerization of such a (meth)acrylic composition. Embodiments also relate to a (meth)acrylic composite material comprising a cavity filled with the (meth)acrylic foam, a method for preparing such (meth)acrylic composite material comprising a cavity filled with the (meth)acrylic foam and an object comprising such (meth)acrylic composite material comprising a cavity filled with the (meth)acrylic foam.

### FIELD OF THE INVENTION

The present invention relates to a (meth)acrylic composition suitable for preparing a (meth)acrylic foam, a process for preparing the (meth)acrylic composition and the (meth)acrylic foam and also to a foam material obtained by polymerization of such a (meth)acrylic composition.

In particular the present invention relates to a (meth)acrylic composition suitable for preparing a (meth)acrylic foam, said meth)acrylic composition is comprising a liquid polymerizable (meth)acrylic syrup, a blowing agent and an initiating system for starting polymerization of said composition, a process for preparing the (meth)acrylic composition and the (meth)acrylic foam and also to a foam material obtained by polymerization of such a (meth)acrylic composition.

The invention also relates to a (meth)acrylic composite material comprising a cavity filled with the (meth)acrylic foam, a method for preparing such (meth)acrylic composite material comprising a cavity filled with the (meth)acrylic foam and an object comprising such (meth)acrylic composite material comprising a cavity filled with the (meth)acrylic foam.

### Technical Problem

Foam materials, and especially polymeric foams have many advantages compared to polymeric bulk materials, such as low density, good heat insulation, good sound insulation, high specific strength and corrosion resistance. The foam material is often not used alone, but in combination with other materials such as composite materials. For a better performance, the foam materials should adhere to the composite material.

A composite material is a macroscopic combination of two or more non-miscible materials. The composite material constitutes at least of a matrix material that forms a continuous phase for the cohesion of the structure and a reinforcing material with various architectures for the mechanical properties.

The aim in using composite materials is to achieve a performance from the composite material that is not available from its separate constituents if used alone. Consequently, composite materials are widely used in several industrial sectors as for example building, automotive, nautical or marine, aerospace, transport, leisure, electronics, and sport notably due to their better mechanical performance (higher tensile strength, higher tensile modulus, and higher fracture toughness) in comparison with homogenous materials and their low density.

The most important class in view of volume in commercial industrial scale, are composites with organic matrices, where the matrix material is a generally polymer. The principal matrix or continuous phase of a polymeric composite material is either a thermoplastic polymer or a thermosetting polymer.

One way for preparing a polymeric composite material based on thermoplastic polymers is by using a liquid polymer composition comprising a monomer, commonly known as a “syrup”. Such a syrup is used for blending with a mineral filler or for impregnating the reinforcing material, for example a fibrous substrate; followed by polymerizing.

At the end of the use of object or article comprising the foam material and the composite material, said object or article should be easily recyclable.

There is a need of a composition that can be transformed into a polymeric foam that can be recycled.

There is also a need of a polymeric foam material that adheres easily to thermoplastic composite material, notably a (meth)acrylic composite material.

There is also a need of a composition that can be transformed into a polymeric foam.

There is also a need of process to prepare a composition that can be transformed into a polymeric foam having a polymerization reactivity sufficiently slow in order to have time to transfer the composition, for example to fill up a cavity.

Another aim of the present invention is to propose a process for propose a process for manufacturing a polymeric foam material that can be recycled and that adheres to thermoplastic composite material.

Still another aim of the present invention is to propose a process for manufacturing an object comprising a thermoplastic composite material and a polymeric foam material that adheres to said thermoplastic composite material.

### BACKGROUND OF THE INVENTION

### Prior Art

The document EP0068439 discloses a method for manufacturing object made of foamed polymethyl methacrylate. The process includes the use of a mixture comprising methyl methacrylate, a plasticizer, a foaming agent and a compound to start the polymerization.

The document WO 2013/056845 relates to a composite material comprising a thermoplastic (meth)acrylic matrix and a reinforcing material formed by a fibrous material which may have various shapes and sizes and may be of natural or synthetic origin. The thermoplastic (meth)acrylic matrix may notably be obtained from a viscous liquid composition, referred to as a “liquid (meth)acrylic syrup”, which comprises (meth)acrylic monomers, or mixtures of (meth)acrylic monomers, and oligomers or polymers dissolved in these monomers.

The document US2018/0079882 discloses the production of fine pored PMMA foams using a nucleating agent. Said nucleating agent is added to the monomer mixture before polymerization.

The document US2009/0233053 discloses an epoxy core with expandable microspheres. A method is disclosed of a fabrication of a formed structure, wherein said expandable microspheres between other compounds are mixed with an epoxy resin in order to form a preform. Said preform is later wrapped, put in a mold and heated in order to form a structure.

The document US2020/385564 discloses a foamable acrylic composition, notably for making foamed composite parts.

The document U.S. Pat. No. 6,664,314 discloses moulding compositions for the production of sanitary ware. The moulding composition based on a methyl methacrylate based syrup with up to 85% of a filler comprises as well deformable propellant filled hollow microspheres.

None of the cited prior art discloses a liquid (meth)acrylic syrup comprising one or more (meth)acrylic polymers, one or more (meth)acrylic monomers and a blowing agent, in particular a moulded part comprising a (meth)acrylic composite material having a cavity filled with the (meth)acrylic foam made from such a liquid (meth)acrylic syrup.

### BRIEF DESCRIPTION OF THE INVENTION

Surprisingly it has been found that a (meth)acrylic composition MC1 comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 25 parts by weight of blowing agent,
(c) optionally from 0.01 part by weight to 5 parts by weight of a polymerization initiator
(d) optionally between 100 ppm and 10 000 ppm of an accelerator; allows to provide a composition for the preparation of (meth)acrylic polymeric foams that possesses a good adhesion and once polymerized yields to foams that are recyclable.

Surprisingly it has also been found that a (meth)acrylic composition MC1 comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 25 parts by weight of blowing agent,
(c) from 0.01 part by weight to 5 parts by weight of a polymerization initiator
(d) between 100 ppm and 10 000 ppm of an accelerator;
allows to provide a composition for the preparation of (meth)acrylic polymeric foams that polymerizes and foams at low temperatures, that possesses a good adhesion to (meth)acrylic composite materials and once polymerized yields to polymeric foams that are recyclable.

Surprisingly it has also been found that a (meth)acrylic composition MC1 comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 25 parts by weight of blowing agent,
(c) from 0.01 part by weight to 5 parts by weight of a polymerization initiator
(d) between 100 ppm and 10 000 ppm of an accelerator;
   can be used for the preparation of (meth)acrylic polymeric foams that possesses a good adhesion to (meth)acrylic composite materials and used for the preparation of polymeric foams that is recyclable.

Surprisingly it has been found that a process for preparing a moulded part MP1 comprising a (meth)acrylic composite material MCM1 and a (meth)acrylic foam MF1, said process is comprising the following steps:
(i) providing a (meth)acrylic composite material MCM1 comprising a cavity,
(ii) providing the (meth)acrylic composition MC1 comprising:
   (a) 100 parts by weight of a liquid (meth)acrylic syrup comprising:
      (a₁) from 1% by weight to 50% by weight of one or more (meth)acrylic polymers P1, and
      (a₂) from 50% by weight to 99% by weight of one or more (meth)acrylic monomers M1, each monomer M1 comprising only one (meth)acrylic function per monomer,
   (b) from 0.5 parts by weight to 25 parts by weight of blowing agent,
   (c) from 0.01 part by weight to 5 parts by weight of a polymerization initiator
   (d) between 100 ppm and 10 000 ppm of an accelerator;
(iii)transferring the (meth)acrylic composition MC1 into the cavity of (meth)acrylic composite material,
(iv)polymerizing the (meth)acrylic composition MC1 yields to a molded part that has a good adhesion between the (meth)acrylic composite material MCM1 and the (meth)acrylic foam MF1 and a molded part that can be recycled.

### BRIEF DESCRIPTION OF DRAWINGS

FIG. 1 shows a (meth)acrylic composite material MCM1 (20) in form of a short tube (10) comprising a cavity (30).

FIG. 1a) shows a top view of the short tube (10) made of (meth)acrylic composite material MCM1 (20) comprising a cavity (30).

FIG. 1b) shows side view of tube (10) along the axis A-A′ of FIG. 1a).

FIG. 1c) shows a perspective view of the short tube (10) comprising a cavity (30).

FIG. 2 shows moulded part MP1 in form of a short tube (10) comprising a (meth)acrylic composite material MCM1 (20) having the cavity filled with the (meth)acrylic foam MF1 (40).

FIG. 2a) shows the top view, FIG. 2b) shows side view of tube (10) along the axis A-A′ of FIG. 2a) and FIG. 2c) shows a perspective view.

FIG. 3a shows a surf board (15) made of a (meth)acrylic composite material MCM1 (20) comprising a cavity (30), that is not shown in FIG. 3a.

FIG. 3b is side view along the axis A-A′ of FIG. 3a showing the cavity (30) that is formed from a first part (20a) and a second part (20b) of (meth)acrylic composite material MCM1 (20), put together at contact line (50).

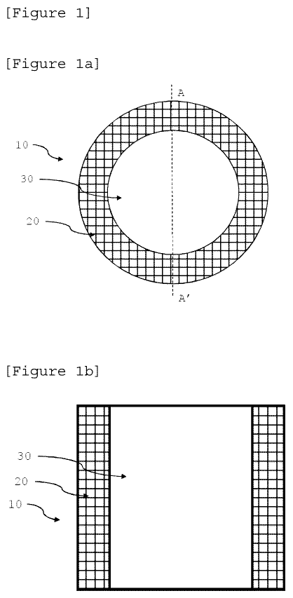

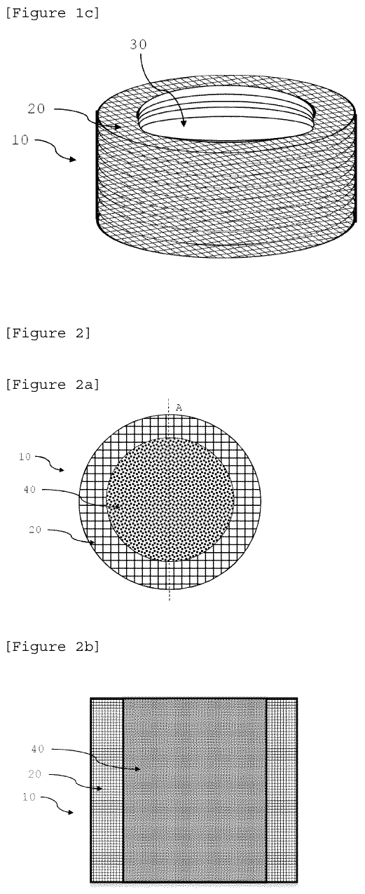

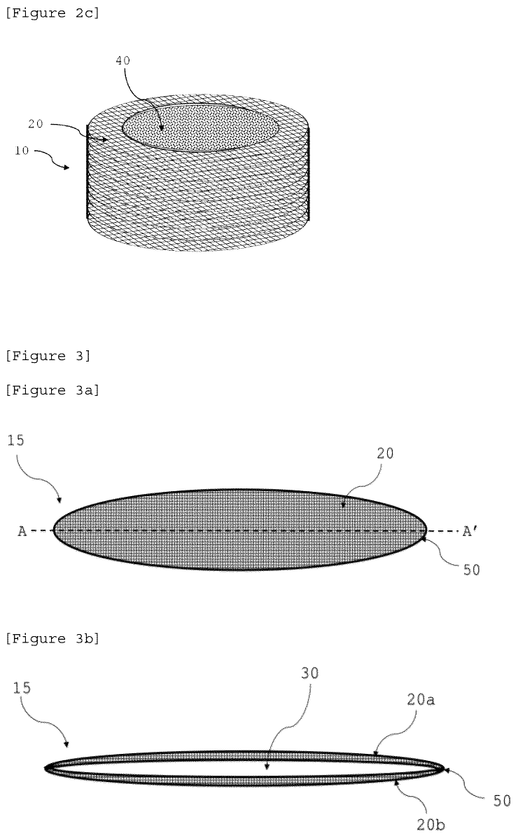

### DETAILED DESCRIPTION OF THE INVENTION

According to a first aspect, the present invention relates to a (meth)acrylic composition MC1, said composition is comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 25 parts by weight of blowing agent,
(c) optionally from 0.01 part by weight to 5 parts by weight of a polymerization initiator
(d) optionally between 100 ppm and 10 000 ppm of an accelerator.

According to a second aspect, the present invention relates to a (meth)acrylic composition MC1, said composition is comprising:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 25 parts by weight of blowing agent,
(c) from 0.01 part by weight to 5 parts by weight of a polymerization initiator
(d) between 100 ppm and 10 000 ppm of an accelerator.

According to a third aspect, the present invention relates to a process for preparing a (meth)acrylic composition MC1 comprising following steps:
(i) providing component (a) the liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(ii) adding for 100 parts of (a) component (b) from 0.5 parts by weight to 25 parts by weight of a blowing agent, optionally component (c) from 0.01 part by weight to 5 parts by weight of a polymerization initiator and optionally component (d) between 100 ppm and 10 000 ppm of an accelerator,
(iii) mixing the components (a) to (b) or (a) to (d).

According to a fourth aspect, the present invention relates to a process for preparing a (meth)acrylic composition MC1, process is comprising following steps:
(i) providing component (a) the liquid (meth)acrylic syrup comprising:
(a₁) from 1% by weight to 50% by weight of one or more (meth)acrylic polymers P1, and
(a₂) from 50% by weight to 99% by weight of one or more (meth)acrylic monomers M1, each monomer M1 comprising only one (meth)acrylic function per monomer,
(ii) adding for 100 parts of (a) component (b) from 0.5 parts by weight to 25 parts by weight of a blowing agent, component (c) from 0.01 part by weight to 5 parts by weight of a polymerization initiator and component (d) between 100 ppm and 10 000 ppm of an accelerator,
(iii) mixing the components (a) to (d).

According to a fifth aspect the present invention relates to the use of a (meth)acrylic composition MC1 to prepare a foam or foamed material, said (meth)acrylic composition MC1 comprises:
(a) 100 parts by weight of a liquid (meth)acrylic syrup comprising:
   (a₁) from 1% by weight to 50% by weight of one or more (meth)acrylic polymers P1, and
   (a₂) from 50% by weight to 99% by weight of one or more (meth)acrylic monomers M1, each monomer M1 comprising only one (meth)acrylic function per monomer,
(b) from 0.5 parts by weight to 25 parts by weight of blowing agent,
(c) from 0.01 part by weight to 5 parts by weight of a polymerization initiator
(d) between 100 ppm and 10 000 ppm of an accelerator.

According to a sixth aspect the present invention relates to a (meth)acrylic foam MF1 prepared by polymerization of the (meth)acrylic composition MC1.

According to a seventh aspect the present the present invention relates to a process for preparing a (meth)acrylic foam MF1, said process comprises the following steps:
(i) providing a (meth)acrylic composition MC1 according to first or second aspect,
(ii) optionally filling or pouring the (meth)acrylic composition MC1 into a cavity (30),
(iii) polymerizing the (meth)acrylic composition MC1.

According to an eight aspect the present the present invention relates to a moulded part MP1 comprising a (meth)acrylic composite material MCM1 having a cavity (30) filled with the (meth)acrylic foam MF1.

According to an ninth aspect the present the present invention relates to a method for preparing the moulded part MP1 according to the eighth aspect, said method is comprising the following steps:
(i) providing a (meth)acrylic composite material MCM1 comprising a cavity (30),
(ii) providing the (meth)acrylic composition MC1,
(iii) transferring the (meth)acrylic composition MC1 into the cavity (30) of (meth)acrylic composite material MC1,
(iv) polymerizing the (meth)acrylic composition MC1.

The term “(meth)acrylic monomer” covers both an acrylic monomer and a methacrylic monomer. Similarly, the term “(meth)acrylic polymer” covers not only an acrylic homopolymer but also a methacrylic homopolymer, an acrylic copolymer and a methacrylic copolymer.

By the term “PMMA” as used are denoted homo- and copolymers of methylmethacrylate (MMA), for the copolymer of MMA the weight ratio of MMA inside the PMMA is at least 50 wt %.

By the term “initiator” as used is denoted a chemical species that forms compound or an intermediate compound that starts the polymerization of a monomer, that to capable of linking successively with a large number of other monomers into a polymeric compound.

By the term “polymer composite” as used is denoted a multicomponent material comprising multiple different phase domains in which at least one type of phase domain is a continuous phase and in which at least one component is a polymer.

By the term “thermoplastic” as used is denoted a polymer that turns to a liquid or becomes more liquid or less viscous when heated and that can take on new shapes by the application of heat and optionally pressure. This applies also for slightly crosslinked thermoplastic polymers that can be thermoformed when heated above the softening temperature.

By the term “cavity” as used is denoted an empty space within a solid object. The solid object could be for example an hollow profile, a hollow tube, the space between at least two sheets (flat or other form, with varying or constant distance between the sheets) or any kind of mold or mold type having an upper and lower part both forming a cavity.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

The liquid (meth)acrylic syrup (a) of the composition according to the invention comprises (a₁) a (meth)acrylic polymer P1 and (a₂) a (meth)acrylic monomer M1.

The liquid (meth)acrylic syrup (a) according to the (meth)acrylic composition MC1 of invention comprises between 1 wt % and 50 wt % of a (meth)acrylic polymer P1 and between 50 wt % and 99 wt % of a (meth)acrylic monomer M1. Preferably the liquid (meth)acrylic syrup comprises between 2 wt % and 50 wt % of a (meth)acrylic polymer P1 and between 50 wt % and 98 wt % of a (meth)acrylic monomer M1, more preferably between 2 wt % and 40 wt % of a (meth)acrylic polymer P1 and between 60 wt % and 98 wt % of a (meth)acrylic monomer M1, still more preferably between 3 wt % and 40 wt % of a (meth)acrylic polymer P1 and between 60 wt % and 97 wt % of a (meth)acrylic monomer M1, advantageously between 3 wt % and 35 wt % of a (meth)acrylic polymer P1 and between 65 wt % and 97 wt % of a (meth)acrylic monomer M1 and more advantageously between 3 wt % and 30 wt % of a (meth)acrylic polymer P1 and between 70 wt % and 97 wt % of a (meth)acrylic monomer M1.

The dynamic viscosity of the liquid (meth)acrylic syrup is in a range from 10 mPa*s to 10000 mPa*s, preferably from 20 mPa*s to 7000 mPa*s and advantageously from 20 mPa*s to 5000 mPa*s and more advantageously from 20 mPa*s to 2000 mPa*s and even more advantageously between 20 mPa*s and 1000 mPa*s. The viscosity of the syrup can be easily measured with a Rheometer or viscosimeter. The dynamic viscosity is measured at 25 °C. If the liquid (meth)acrylic syrup has a Newtonian behaviour, meaning no shear thinning, the dynamic viscosity is independent of the shearing in a rheometer or the speed of the mobile in a viscometer. If the liquid composition has a non-Newtonian behaviour, meaning shear thinning, the dynamic viscosity is measured at a shear rate of 1s⁻¹ at 25 °C.

As regards the liquid (meth)acrylic syrup (a), it comprises (a₁) the (meth)acrylic monomer M1 and (a₂) the (meth)acrylic polymer P1. Once the (meth)acrylic composition MC1 has been polymerized, the (meth)acrylic monomer M1 copolymerizes with (meth)acrylic monomer M2 and is transformed to a (meth)acrylic polymer P2 comprising the monomeric units of (meth)acrylic monomer M1 and and other possible comonomers.

The liquid (meth)acrylic syrup of the (meth)acrylic composition MC1 according to the invention may comprise only one (meth)acrylic polymer P1, but may equally comprise a mixture of two, three or even more (meth)acrylic polymers P1. If there is a mixture of different (meth)acrylic polymer P1, the difference is the composition of the respective (meth)acrylic polymer P1 or the molecular weight of the respective (meth)acrylic polymer P1 or both.

The or each (meth)acrylic polymer P1 included in the liquid (meth)acrylic syrup may in particular be chosen from:
polyalkyl acrylates which comprise alkyl acrylate homopolymers and alkyl acrylate copolymers, and
polyalkyl methacrylates which comprise alkyl methacrylate homopolymers and alkyl methacrylate copolymers.

According to a preferred embodiment, the or each (meth)acrylic polymer P1 is a polymethyl methacrylate (PMMA), it being understood that, as indicated above, the polymethyl methacrylate (PMMA) may denote a methyl methacrylate (MMA) homopolymer or an MMA copolymer.

In particular, in the case where the liquid (meth)acrylic syrup comprises a mixture of two or more polymethyl methacrylates P1, this mixture may be formed by mixing at least two MMA homopolymers having a different molecular weight, by mixing at least two MMA copolymers having an identical monomer composition and a different molecular weight, by mixing at least two MMA copolymers having a different monomer composition or by mixing at least one MMA homopolymer and at least one MMA copolymer.

According to a first preferred embodiment the (meth)acrylic polymer P1 is chosen from a methyl methacrylate homopolymer or a methyl methacrylate copolymer or a mixture thereof, methyl methacrylate advantageously representing at least 50% by weight of the or of each (meth)acrylic polymer P1.

According to one embodiment of the invention, methyl methacrylate represents at least 55% by weight of the or each (meth)acrylic polymer P1.

According to another particular embodiment, the or each (meth)acrylic polymer P1 comprises at least 70%, advantageously at least 80%, preferentially at least 90% and more preferentially at least 95% by weight of methyl methacrylate.

When the or each (meth)acrylic polymer P1 is a methyl methacrylate (MMA) copolymer, it may comprise at least one comonomer containing at least one ethylenic unsaturation and which is capable of copolymerizing with methyl methacrylate. Among these comonomers, mention may notably be made of acrylic and methacrylic acids and alkyl (meth)acrylates in which the alkyl group contains from 1 to 12 carbon atoms. Alkyl (meth)acrylates means an alkyl ester of acrylic acid or methacrylic acid. As examples of comonomers, mention may be made of methyl acrylate and ethyl, butyl or 2-ethylhexyl (meth)acrylate.

Advantageously, the or each (meth)acrylic polymer P1 is a homopolymer of methyl methacrylate or a copolymer of methyl methacrylate and of an alkyl acrylate or an alkyl methacrylate in which the alkyl group contains from 1 to 12 carbon atoms, advantageously from 1 to 6 carbon atoms and preferentially from 1 to 4 carbon atoms.

According to a first preferred embodiment, when the or each (meth)acrylic polymer P1 is a methyl methacrylate (MMA) copolymer, this methyl methacrylate (MMA) copolymer comprises from 70% to 99.9%, advantageously from 80% to 99.9%, preferentially from 90% to 99.9% and more preferentially from 95% to 99.9% by weight of methyl methacrylate and from 0.1% to 30%, advantageously from 0.1% to 20%, preferentially from 0.1% to 10% and more preferentially from 0.1% to 5% by weight of at least one comonomer containing at least one ethylenic unsaturation that can copolymerize with methyl methacrylate. Preferably, the or each comonomer is chosen from methyl acrylate and ethyl acrylate.

In an advantageous variant of the first preferred embodiment, when the or each (meth)acrylic polymer P1 is a methyl methacrylate (MMA) copolymer, the (meth)acrylic polymer P1 is a copolymer of methyl methacrylate and of alkyl acrylate.

In a preferred variant of the first preferred embodiment, when the or each (meth)acrylic polymer P1 is a methyl methacrylate (MMA) copolymer, the (meth)acrylic polymer P1 is a copolymer of methyl methacrylate and of methyl acrylate or ethylacrylate.

According to a second preferred embodiment, when the or each (meth)acrylic polymer P1 is a methyl methacrylate (MMA) copolymer, this methyl methacrylate (MMA) copolymer comprises from 50% to 99.9%, advantageously from 52% to 99.9%, preferentially from 53% to 99.9% and more preferentially from 55% to 99.9% by weight of methyl methacrylate and from 0.1% to 50%, advantageously from 0.1% to 48%, preferentially from 0.1% to 47% and more preferentially from 0.1% to 45% by weight of at least one comonomer containing at least one ethylenic unsaturation that can copolymerize with methyl methacrylate. Preferably, the or each comonomer is chosen from methyl acrylate, ethyl acrylate, ethyl methacrylate, propyl acrylate, propyl methacrylate, butyl acrylate or butyl methacrylate.

The weight-average molecular weight, noted as M_{w}, of the or each (meth)acrylic polymer P1 is generally high and may consequently be greater than 40 000 g/mol, advantageously greater than 45 000 g/mol and preferentially greater than 50 000 g/mol. The weight-average molecular weight may be measured by size exclusion chromatography (SEC).

The (meth)acrylic polymer P1, if not crosslinked, usually has a melt mass-flow rate (MFR) ISO 1133-2:2011 (230 °C/3.8 kg) of between 0.1 g/10 min and 20 g/10 min or the melt mass-flow rate is between 0.2 g/10 min and 18 g/10 min, or between 0.3 g/10 min and 16 g/10 min or between 0.4 g/10 min and 13 g/10 min.

The liquid (meth)acrylic syrup of the (meth)acrylic composition MC1 according to the invention may comprise only one (meth)acrylic monomer M1, but may equally comprise a mixture of two, three or even more (meth)acrylic monomers M1. This would be (meth)acrylic monomer M1a, (meth)acrylic monomer M1b, (meth)acrylic monomers M1c and so on.

Whether the liquid (meth)acrylic syrup comprises one or more (meth)acrylic monomers M1, the or each (meth)acrylic monomer M1 comprises only one (meth)acrylic function per monomer.

As regards the (meth)acrylic monomer (M1), the monomer is chosen from alkyl acrylic monomers, alkyl methacrylic monomers, hydroxyalkyl acrylic monomers and hydroxyalkyl methacrylic monomers, and mixtures thereof. Alkyl acrylic monomer or alkyl methacrylic monomer means an alkyl ester of acrylic acid or methecrylic acid.

Preferably, the (meth)acrylic monomer (M1) is chosen from hydroxyalkyl acrylic monomers, hydroxyalkyl methacrylic monomers, alkyl acrylic monomers, alkyl methacrylic monomers and mixtures thereof, the alkyl group containing from 1 to 22 linear, branched or cyclic carbons; the alkyl group preferably containing from 1 to 12 linear, branched or cyclic carbons.

Advantageously, the (meth)acrylic monomer (M1) is chosen from methyl methacrylate, ethyl methacrylate, methyl acrylate, ethyl acrylate, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

According to a preferred embodiment, at least 50% by weight and preferably at least 60% by weight of the (meth)acrylic monomer (M1) is methyl methacrylate.

According to a first more preferred embodiment, at least 50% by weight, preferably at least 60% by weight, more preferably at least 70% by weight, advantageously at least 80% by weight and even more advantageously 90% by weight of the monomer (M1) is a mixture of methyl methacrylate with optionally at least one other monomer.

In a first variant of the invention, the liquid (meth)acrylic syrup comprises:
(a₁) from 3% by weight to 45% by weight and preferentially from 3% by weight to 40% by weight of the (meth)acrylic polymer(s) P1, and
(a₂) from 55% by weight to 97% by weight and preferentially from 60% by weight to 97% by weight of the (meth)acrylic monomer(s) M1.

In a second variant of the invention, the liquid (meth)acrylic syrup comprises:
(a₁) from 3% by weight to 25% by weight and preferentially from 4% by weight to 25% by weight and more preferentially from 5% by weight to 25% by weight and even more preferentially from 5% by weight to 24% by weight of the (meth)acrylic polymer(s) P1, and
(a₂) from 75% by weight to 97% by weight and preferentially from 75% by weight to 96% by weight and more preferentially from 75% by weight to 95% by weight and even more preferentially from 76% by weight to 95% by weight of the (meth)acrylic monomer(s) M1.

In an advantageous variant, the or each (meth)acrylic polymer P1 and the or each (meth)acrylic monomer M1 of the liquid (meth)acrylic syrup comprise at least one same (meth)acrylic unit, such a variant making it possible to optimize the solubility of the (meth)acrylic polymer(s) P1 in the (meth)acrylic monomer(s) M1.

Preferentially, the or each (meth)acrylic polymer P1 is chosen from a homopolymer of methyl methacrylate or copolymer of methyl methacrylate and of methyl acrylate and a copolymer of methyl methacrylate and of ethyl acrylate or a copolymer of methyl methacrylate and of butyl acrylate or a copolymer of methyl methacrylate and of butyl methacrylate, the respective comonomer being present at most at 45 wt % in the copolymer.

Preferentially, the (meth)acrylic monomer M1 is methyl methacrylate.

In a first advantageous variant, the liquid (meth)acrylic syrup comprises a (meth)acrylic polymer P1, rather than a mixture of (meth)acrylic polymers P1.

In a second advantageous variant, the liquid (meth)acrylic syrup comprises a mixture of two (meth)acrylic polymers P1.

In another advantageous variant, the liquid (meth)acrylic syrup comprises a (meth)acrylic monomer M1, rather than a mixture of (meth)acrylic monomers M1.

Stabilizers, or reaction inhibitors, may also be present in the liquid (meth)acrylic syrup to prevent spontaneous polymerization of the (meth)acrylic monomer(s) M1.

These stabilizers may notably be chosen from hydroquinone (HQ), hydroquinone monomethyl ether (HQME), 2,6-di-tert-butyl-4-methylphenol (BHT), 2,6-di-tert-butyl-4-methoxyphenol (Topanol O) and 2,4-dimethyl-6-tert-butylphenol (Topanol A).

These stabilizers may be present, in the liquid (meth)acrylic syrup, in a proportion of not more than 5 parts by weight, advantageously not more than 4 parts by weight and preferentially in a proportion of between 0.3 and 3 parts by weight, per 100 parts by weight of the sum of the (meth)acrylic polymer(s) P1 and of the (meth)acrylic monomer(s) M1.

As regards the blowing agent, it can be chosen from a physical blowing agent, a chemical blowing agent, expandable beads or preexpanded beads.

In a first preferred embodiment, the blowing agent is chosen from a physical blowing agent.

In a second preferred embodiment, the blowing agent is chosen from a chemical blowing agent.

In a third preferred embodiment, the blowing agent is chosen from expandable beads.

In a fourth preferred embodiment, the blowing agent is chosen from expandable polymeric beads.

In a fifth preferred embodiment, the blowing agent is chosen from expandable polymeric beads comprising an outer layer comprising inorganic compounds.

In a sixth preferred embodiment, the blowing agent is chosen from preexpanded beads.

In a seventh preferred embodiment, the blowing agent is chosen from preexpanded polymeric beads.

In an eighth preferred embodiment, the blowing agent is chosen from preexpanded polymeric beads comprising an outer layer comprising inorganic compounds.

In a ninth preferred embodiment, the blowing agent is chosen from a mixture of at least two of any beads from the previous embodiments.

In a tenth preferred embodiment, the blowing agent is chosen from a mixture of at least one expandable bead from the previous embodiments and at least one preexpanded bead from the previous embodiments.

If the blowing agent is a bead, it has usually a volume average particle diameter between 1 μm and 500 μm.

The blowing agent is present from 0.5 parts by weight to 25 parts by weight in the (meth)acrylic composition MC1 for 100 parts by weight of a liquid (meth)acrylic syrup.

Preferably, the blowing agent is present from 1 parts by weight to 25 parts by weight and more preferably from 1 parts by weight to 20 parts by weight for 100 parts by weight of a liquid (meth)acrylic syrup.

Most preferably the blowing agent is present from 1 parts by weight to 15 parts by weight for 100 parts by weight of a liquid (meth)acrylic syrup.

The (meth)acrylic composition MC1 according to one aspect of the invention also comprises a polymerization initiator, the function of which is to ensure the start of polymerization of the (meth)acrylic monomer M1.

The polymerization initiator may be chosen from organic peroxides, peroxy esters, peroxy acetals and azo compounds.

The polymerization initiator may in particular be chosen from diacyl peroxides, peroxy esters, peroxydicarbonates, dialkyl peroxides, peroxyacetals, hydroperoxide or peroxyketale.

In one embodiment, the polymerization initiator is chosen from benzoyl peroxide.

In another embodiment the polymerization initiator is chosen from diisobutyryl peroxide, cumyl peroxyneodecanoate, di(3-methoxybutyl) peroxydicarbonate,1,1,3,3-Tetramethylbutyl peroxyneodecanoate, cumyl peroxyneoheptanoate, di-n-propyl peroxydicarbonate, tert-amyl peroxyneodecanoate, di-sec-butyl peroxydicarbonate, diisopropyl peroxydicarbonate, di(4-tert-butylcyclohexyl) peroxydicarbonate, di-(2-ethylhexyl)-peroxydicarbonate, tert-amyl peroxyneodecanoate, tert-butyl peroxyneodecanoate, di-n-butyl peroxydicarbonate, dicetyl peroxydicarbonate, dimyristyl peroxydicarbonate, 1,1,3,3-tetramethylbutylperoxypivalate, tert-butyl peroxyneoheptanoate, tert-amyl peroxypivalate, tert-butyl peroxypivalate, di-(3,5,5-trimethylhexanoyl)-peroxide, dilauroyl peroxide, didecanoyl peroxide, 2,5-dimethyl-2,5-di(2-ethylhexanoylperoxy)-hexane, 1,1,3,3-tetramethylbutyl peroxy-2-ethylhexanoate, tert-amyl peroxy-2-ethylhexanoate, dibenzoyl peroxide, tert-butyl peroxy-2-ethylhexanoate, tert-butyl peroxydiethylacetate, tert-butyl peroxyisobutyrate, 1,1-di-(tert-butylperoxy)-3,3,5-trimethylcyclohexane, 1,1-di(tert-amylperoxy)cyclohexane, 1,1-di-(tert-butylperoxy)-cyclohexane, tert-amyl peroxy-2-ethylhexylcarbonate, tert-amyl peroxyacetate, tert-butyl peroxy-3,5,5-trimethylhexanoate, 2,2-di-(tert-butylperoxy)-butane, tert-butyl peroxyisopropylcarbonate, tert-butyl peroxy-2-ethylhexylcarbonate, tert-amyl peroxybenzoate, tert-butyl peroxyacetate, butyl 4,4-di(tert-butylperoxy)valerate, tert-butyl peroxybenzoate, di-tert-amylperoxide, dicumyl peroxide, di-(2-tert-butyl-peroxyisopropyl)-benzene, 2,5-dimethyl-2,5-di-(tert-butylperoxy)-hexane, tert-butylcumyl peroxide, 2,5-dimethyl-2,5-di(tert-butylperoxy)hexyne-3, di-tert-butyl peroxide, 3,6,9-triethyl-3,6,9-trimethyl-1,4,7-triperoxonane, 2,2′-azobis-isobutyronitrile (AIBN), 2,2′-azodi-(2-methylbutyronitrile), azobisisobutyramide, 2,2′-azobis(2,4-dimethylvaleronitrile), 1,1′-Azodi(hexahydrobenzonitrile), or 4,4′-azobis(4-cyanopentanoic).

The (meth)acrylic composition MC1 according to the invention may comprise from 0.01 part by weight to 5 parts by weight of polymerization initiator.

According to a particular embodiment, the (meth)acrylic composition MC1 according to the invention comprises from 0.02 part by weight to 4 parts by weight and advantageously 0.03 part by weight to 3 parts by weight of polymerization initiator per 100 parts by weight of the liquid (meth)acrylic syrup.

That which has just been described for a polymerization initiator is entirely transposable to an initiator system, such a system consisting of a polymerization initiator and a polymerization activator or accelerator.

The (meth)acrylic composition MC1 according to the invention may also effectively further according to certain aspects comprise a polymerization activator or accelerator.

According to a particular embodiment, the (meth)acrylic composition according to the invention comprises between 100 ppm and 10 000 ppm, advantageously between 100 ppm and 7 000 pmm and preferably between 200 ppm and 5 000 ppm of polymerization activator or accelerator per 100 parts by weight of the (meth)acrylic syrup.

The present invention relates also to a process for preparing a (meth)acrylic composition MC1.

According to the invention, this process comprises the steps: i) providing the components a) to b) or a) to d), ii) adding component(s) b) or b) to d) to a) and ii) mixing the components a) to b) or a) to d).

Step iii) of the preparing process according to the invention is performed by mixing all of the components included in the (meth)acrylic composition MC1, care being taken to prepare, firstly, the liquid (meth)acrylic syrup and then to introduce, into this (meth)acrylic syrup, the blowing agent and, where appropriate, the polymerization activator or accelerator, the polymerization initiator being introduced last.

This mixing may be manual or may be performed using a mixing means.

Optionally, the mixing is performed by stirring, and for a time of between 1 minutes and 6 hours, advantageously between 2 minutes and 2 hours, more advantageously between 3 minutes and 1 hour and preferentially between 4 minutes and 1 hour.

The manufacturing process according to the invention is thus a process that is particularly simple to perform and which may be readily performed in the current facilities dedicated to the manufacture of (meth)acrylic composition.

The (meth)acrylic composition MC1 comprising the compounds a) to d) or a) to e) has a viscosity between 50 mPa*s and 10 000 Pa*s at 23 °C.

Preferably the viscosity of (meth)acrylic composition MC1 comprising the compounds a) to d) or a) to e) at 23 °C is in a range from 50 mPa*s to 100 Pa*s, more preferably from 50 mPa*s to 50 Pa*s, still more preferably from 50 mPa*s to 25 Pa*s, even still more preferably from 50 mPa*s to 20 Pa*s, even still more preferably between 50 mPa*s and 15 Pa*s, advantageously between 50 mPa*s and 10 OOOmPa*s and more advantageously between 50 mPa*s and 5 OOOmPa*s.

The (meth)acrylic composition MC1 according to the invention, may also be used for prepare a foam or foamed material.

One aspect of the present invention is a (meth)acrylic foam MF1 prepared by polymerization of the (meth)acrylic composition MC1.

Another aspect of the invention is the use of the (meth)acrylic foam MF1 to fill a cavity (30).

Still another aspect of the present invention process to prepare a (meth)acrylic foam MF1.

Said process to prepare a (meth)acrylic foam MF1 is comprising the following steps:
(i) providing a (meth)acrylic composition MC1 as defined before,
(ii) optionally filling or pouring the (meth)acrylic composition MC1 into a cavity (30),
(iii) polymerizing the (meth)acrylic composition MC1.

The different embodiments of provided (meth)acrylic composition MC1 and its respective components can be combined in any combination.

In a first preferred embodiment of the process to prepare a (meth)acrylic foam MF1, the (meth)acrylic composition MC1 is filled or poured into a cavity (30). The polymerization takes place inside the cavity (30). The foaming takes place or at least begins during the polymerization step (iii).

The polymerization takes place at a temperature below 140 °C.

The polymerization takes place at a temperature above 10 °C.

The polymerization starts a temperature above 10 °C and increases during the polymerization.

This temperature during polymerization is sufficient high to activate the blowing agent. The temperature during the polymerization can rise to above 100 °C or above 80 °C or above 60 °C.

Polymerization and foaming take place together.

In one embodiment, the foaming is made by the exothermic energy coming from the polymerization reaction.

In a second preferred embodiment of the process to prepare a (meth)acrylic foam MF1, the (meth)acrylic composition MC1 is filled or poured into a cavity (30) formed by a thermoplastic composite material. Preferably the cavity (30) is formed by a (meth)acrylic composite material MCM1 (20). For the second preferred embodiment of the process to prepare a (meth)acrylic foam MF1, the temperature conditions are the same as for the first preferred embodiment. Polymerization and foaming can take place together as well.

The present invention relates in an additional aspect to a moulded part MP1 comprising a (meth)acrylic composite material MCM1 having a cavity filled with the (meth)acrylic foam MF1.

In a first preferred embodiment the (meth)acrylic composite material MCM1 is a fiber reinforced (meth)acrylic composite material.

In a second preferred embodiment the (meth)acrylic composite material MCM1 is a particle reinforced (meth)acrylic composite material.

According to an embodiment of the invention, this moulded part MP1 is obtained by polymerization of a (meth)acrylic composition MC1 in a cavity of (meth)acrylic composite material MCM1.

The moulded part MP1 according to the invention may be used in many sectors and notably in the housing, motor vehicle, railway, sports, aeronautical industry, aerospace, photovoltaic or wind power sector, and in marine applications and medical applications.

By way of example following objects or articles may comprise a moulded part MP1: a windblade, a surfboard, a boat, a pressure vessel, tubes, pipes, profiles.

### [Methods]

The weight-average molecular weight may be measured by size exclusion chromatography (SEC). The chromatography column is calibrated with PMMA standards having a molecular weight between 402 g/mol and 1 900 000 g/mol. The average molecular weight is expressed in g/mol for the number and average molecular weight Mn and Mw respectively. For the measurement, the concentration is 1 g/L.

The viscosity of the (meth)acrylic compositions comprising at least the components a1) and a2) is measured with a Brookfield viscosimeter at 23 °C, according to ISO 2555:2018 “Plastics—Resins in the liquid state or as emulsions or dispersions—Determination of apparent viscosity using a single cylinder type rotational viscometer method”.

### Examples

The compounds used for the preparation of the various (meth)acrylic compositions are the following:
as (meth)acrylic polymer P1: a PMMA formed by a copolymer of methyl methacrylate and of ethyl acrylate, from company Altuglas under the name Altuglas® BS 520B,
as (meth)acrylic monomer M1: a methyl methacrylate stabilized with hydroquinone monomethyl ether,
as initiator benzoyl peroxide (BPO) is used,
as accelator DMPT (N,N-dimethyl-p-toluidine) is used,
as blowing agent: unexpanded microspheres Dualite® from company Chase.

A syrup S1 is prepared by first dissolving 20 parts by weight of the PMMA (BS520 a copolymer of MMA comprising ethyl acrylate as a comonomer) as P1 in 80 parts by weight of methyl methacrylate as (meth)acrylic monomer M1, which is stabilized with MEHQ (hydroquinone monomethyl ether). The syrup S1 has a viscosity of 104 m*Pas at 23 °C.

Syrup S1 is used to prepare the composition of the examples of the invention and comparative examples by adding additional compounds.

To 100 parts of syrup S1 then 5 parts by weight of Dualite U011-128D unexpanded microspheres are added as blowing agent.

Also 3 parts of BPO are added.

TABLE 1
prepared compositions in phr if not indicated otherwise

| | Quantity/[phr] | Comparative |
|---|---|---|
| | Example 1 | example |
| Syrup S1 | 100 | 100 |
| Blowing agent | 5 | 0 |
| Initiator | 3 | 3 |
| accelerator | 1 | 1 |

The mixtures from table 1 are polymerized.

Following results are obtained as summarized in table 2.

TABLE 2
Characteristics of obtained polymerized compositions

| | Quantity/[phr] | Comparative |
|---|---|---|
| | Example 1 | example |
| Density | 150 kg/m3 | 1200 kg/m3 |
| Foam quality | Homogeneous | Bulk material |

According to the composition of the example, a homogeneous foam is obtained.

1. A (meth)acrylic composition MC1 comprising:
(a) 100 parts by weight of a liquid (meth)acrylic syrup comprising:
(a₁) from 1% by weight to 50% by weight of one or more (meth)acrylic polymer(s) P1, and
(a₂) from 50% by weight to 99% by weight of one or more (meth)acrylic monomers M1, each monomer M1 comprising only one (meth)acrylic function per monomer,
(b) from 0.5 parts by weight to 25 parts by weight of a blowing agent,
(c) optionally from 0.01 part by weight to 5 parts by weight of a polymerization initiator
(d) optionally between 100 ppm and 10000 ppm of an accelerator.

2. The (meth)acrylic composition MC1 according to claim 1, wherein it comprises
(c) from 0.01 part by weight to 5 parts by weight of a polymerization initiator
(d) between 100 ppm and 10000 ppm of an accelerator.

3. The (meth)acrylic composition MC1 according to claim 1, wherein the one or more (meth)acrylic polymer(s) P1 comprises a mixture of different (meth)acrylic polymer P1, the difference is the composition of the respective (meth)acrylic polymer P1 or the molecular weight of the respective (meth)acrylic polymer P1 or both.

4. The composition according to claim 1, wherein the or each (meth)acrylic polymer P1 is chosen from a methyl methacrylate homopolymer or a methyl methacrylate copolymer or a mixture thereof, methyl methacrylate advantageously representing at least 50% by weight of the or of each (meth)acrylic polymer P1.

5. The composition according to claim 1, wherein the liquid (meth)acrylic syrup has a viscosity between 10 m*Pas and 10 000 mPa*s at 25 °C.

6. The composition according to claim 1, wherein the (meth)acrylic polymer P1 has weight-average molecular weight M_{w} greater than 40 000 g/mol.

7. The composition according to claim 1, wherein the (meth)acrylic polymer P1 has a melt mass-flow rate (MFR) ISO 1133-2:2011 (230 °C/3.8 kg) of between 0.1 g/10 min and 20 g/10 min.

8. The composition according to claim 1, wherein the blowing agent is chosen from a physical blowing agent.

9. The composition according to claim 1, wherein the blowing agent is chosen from a chemical blowing agent.

10. The composition according to claim 1, wherein the blowing agent is chosen from expandable beads.

11. The composition according to claim 1, wherein the blowing agent is chosen from expandable polymeric beads.

12. The composition according to claim 1, wherein the blowing agent is chosen from expandable polymeric beads comprising an outer layer comprising inorganic compounds.

13. The composition according to claim 1, wherein the blowing agent is chosen from preexpanded beads.

14. The composition according to claim 1, wherein the blowing agent is chosen from preexpanded polymeric beads.

15. The composition according to claim 1, wherein the blowing agent is chosen from preexpanded polymeric beads comprising an outer layer comprising inorganic compounds.

16. The composition according to claim 1, wherein the blowing agent is chosen from a mixture of at least two of any beads from any of claims 10 to 15.

17. The composition according to claim 1, wherein the blowing agent is chosen from a mixture of at least one expandable bead and at least one preexpanded bead.

18. The composition according to claim 1, wherein the bead has a volume average particle diameter between 1 μm and 500 μm.

19. The composition according to claim 1, wherein the liquid (meth)acrylic syrup comprises:
(a₁) from 3% by weight to 45% by weight and preferentially from 3% by weight to 40% by weight of the (meth)acrylic polymer(s) P1, and
(a₂) from 55% by weight to 97% by weight and preferentially from 60% by weight to 97% by weight of the (meth)acrylic monomer(s) M1.

20. The composition according to claim 1, wherein the liquid (meth)acrylic syrup comprises:
(a₁) from 3% by weight to 25% by weight and preferentially from 4% by weight to 25% by weight and more preferentially from 5% by weight to 25% by weight and even more preferentially from 5% by weight to 24% by weight of the (meth)acrylic polymer(s) P1, and
(a₂) from 75% by weight to 97% by weight and preferentially from 75% by weight to 96% by weight and more preferentially from 75% by weight to 95% by weight and even more preferentially from 76% by weight to 95% by weight of the (meth)acrylic monomer(s) M1.

21. A process to prepare the (meth)acrylic composition MC1 according to claim 1, comprising the following steps
(i) providing component (a) the liquid (meth)acrylic syrup comprising
(a₁) from 1% by weight to 50% by weight of one or more (meth)acrylic polymers P1, and
(a₂) from 50% by weight to 99% by weight of one or more (meth)acrylic monomers M1, each monomer M1 comprising only one (meth)acrylic function per monomer,
(ii) adding for 100 parts of (a) component (b) from 0.5 parts by weight to 25 parts by weight of a blowing agent,
optionally component (c) from 0.01 part by weight to 5 parts by weight of a polymerization initiator and optionally component (d) between 100 ppm and 10 000 ppm of an accelerator
(iii) mixing the components (a) to (b) or (a) to (d).

22. The process according to claim 21, wherein the mixing is performed by stirring, and for a time of between 1 minutes and 6 hours.

23. Use of the (meth)acrylic composition MC1 according to claim 1 to prepare a foam or foamed material.

24. A (meth)acrylic foam MF1 prepared by polymerization of the (meth)acrylic composition MC1 according to claim 1.

25. A process to prepare a (meth)acrylic foam MF1 comprising the following steps
(i) providing a (meth)acrylic composition MC1 according to claim 1,
(ii) optionally filling or pouring the (meth)acrylic composition MC1 into a cavity,
(iii) polymerizing the (meth)acrylic composition MC1.

26. The process according to claim 25, wherein the (meth)acrylic composition MC1 is filled or poured into a cavity (30).

27. The process according to claim 25, wherein the polymerization takes place inside the cavity (30).

28. The process according to claim 25, wherein foaming takes place or at least begins during the polymerization step (iii).

29. The process according to claim 25, wherein the cavity (30) is formed by a (meth)acrylic composite material MCM1.

30. The process according to claim 25, wherein polymerizing step the temperature is below 140 °C.

31. The process according to claim 25, wherein the temperature during the polymerization can rise to above 100 °C or above 80 °C or above 60 °C.

32. Use of the (meth)acrylic foam MF1 according to claim 24 to fill a cavity.

33. A moulded part MP1 comprising a (meth)acrylic composite material MCM1 having a cavity filled with the (meth)acrylic foam MF1 according to claim 24.

34. A method for preparing the moulded part MP1 according to claim 33, said process is comprising the following steps:
(i) providing a (meth)acrylic composite material MCM1 comprising a cavity,
(ii) providing the (meth)acrylic composition MC1 according to any of claims 1 to 19,
(iii) transferring the (meth)acrylic composition MC1 into the cavity of (meth)acrylic composite material MCM1,
(iv) polymerizing the (meth)acrylic composition MC1.

35. The method according to claim 34, wherein the (meth)acrylic composite material MCM1 is a fiber reinforced (meth)acrylic composite material.

36. The method according to claim 35, wherein the (meth)acrylic composite material MCM1 is a particle reinforced (meth)acrylic composite material.

37. An object comprising the moulded part MP1 according to claim 33.

38. The object according to claim 37 chosen from a windblade, a surfboard, a boat, a pressure vessel, tubes, pipes or profiles.

39. An article comprising the (meth)acrylic composite material MCM1 and the (meth)acrylic foam MF1 according to claim 24.
